(19) United States
(12) Patent Application Publication
(10) Pub. No.: US 2020/0294292 A1
(43) Pub. Date: Sep. 17, 2020

(54) DATA PROCESSING APPARATUS, DISPLAY CONTROL SYSTEM, DATA PROCESSING METHOD, AND COMPUTER PROGRAM PRODUCT

(71) Applicant: KABUSHIKI KAISHA TOSHIBA, Minato-ku (JP)

(72) Inventors: Xinxiao LI, Yokohama (JP); Akira KURODA, Yokohama (JP)

(73) Assignee: KABUSHIKI KAISHA TOSHIBA, Minato-ku (JP)

(21) Appl. No.: 16/555,542

(22) Filed: Aug. 29, 2019

(30) Foreign Application Priority Data
Mar. 14, 2019 (JP) 2019-047659

(51) Int. Cl. G06T 11/20

(52) U.S. Cl. CPC G06T 11/206

(57) ABSTRACT

A data processing apparatus includes one or more processors. The processors generate data for displaying, in parallel coordinates, data of M dimensions (M is a natural number less than N) specified from N dimensions (N is a natural number) by a user's interactive operation. When the specification of the M dimensions is changed, the processors generate data for displaying data of the changed M dimensions in parallel coordinates.

### CROSS-REFERENCE TO RELATED APPLICATIONS

This application is based upon and claims the benefit of priority from Japanese Patent Application No. 2019-047659, filed on Mar. 14, 2019; the entire contents of which are incorporated herein by reference.

### FIELD

Embodiments described herein relate generally to a data processing apparatus, a display control system, a data processing method, and a computer program product.

### BACKGROUND

A technology for transferring data collected by, for example, a sensor to a storage device, and visualizing many pieces of data stored in the storage device on a display device (display) is known. With the increasing variety of sensors and the evolution of the storage technology, data is easily collected while as the amount of plotting data increases, the processing loads of data transfer and plotting increase, which is a bottleneck of an interactive visualization system.

The data to be collected can be interpreted as table data where a dimension (corresponding to an item, a type, or the like) of data is set as a column, and a data sample of each dimension is set as a row. The increase of the data amount includes both of an increase in the number of dimensions and an increase in the number of data samples.

### BRIEF DESCRIPTION OF THE DRAWINGS

FIG. 1 is a block diagram of a display control system according to an embodiment;

FIG. 2 is a flowchart of a data visualization process in the embodiment;

FIG. 3 is a diagram illustrating an example of a display area of parallel coordinates;

FIG. 4 is a diagram illustrating an example of a display screen in parallel coordinates;

FIG. 5 is a diagram illustrating an example of the display screen in parallel coordinates;

FIG. 6 is a diagram for explaining an example of resampling;

FIG. 7 is a diagram illustrating another example of the display screen in parallel coordinates; and

FIG. 8 is a hardware configuration diagram of an apparatus according to the embodiment.

### DETAILED DESCRIPTION

According to one embodiment, a data processing apparatus includes one or more processors. The processors generate data for displaying, in parallel coordinates, data of M dimensions (M is a natural number less than N) specified from N dimensions (N is a natural number) by a user's interactive operation. When the specification of the M dimensions is changed, the processors generate data for displaying data of the changed M dimensions in parallel coordinates. A preferred embodiment of a data processing apparatus according to the invention is described in detail hereinafter with reference to the accompanying drawings.

For example, a method where one- or two-dimensional data is visualized in a two-dimensional (the X-axis+the Y-axis) display space is relatively easy as a data visualization technique. The visualization of three-dimensional data is a method where the Z-axis is added to the X-axis and the Y-axis to display a visualization result on a two-dimensional display plane, changing the eyepoint. Such a method is used to, for example, visualize a physical entity analysis, and visualize scientific simulation data.

For example, parallel coordinates (Parallel Coordinates) and a scatter matrix (Scatter Matrix) are used as techniques for visualizing three or more multidimensional data. Parallel coordinates presents data samples with polylines, placing a plurality of generally equal spaced parallel axes corresponding to a plurality of dimensions. Parallel coordinates can represent multidimensional data in a readily understandable manner.

Visualization in parallel coordinates has problems mainly in degradation of readability and a reduction in plotting performance due to an increase in the number of samples and an increase in the number of dimensions. Parallel coordinates is generally much lower in plotting performance than a line graph, a scatter diagram, a bar chart, and the like. For example, if a graph of parallel coordinates is plotted in SVG (Scalable Vector Graphics) format on a browser of a general-purpose computer or the like, the delay of an operation response is significant even for multidimensional data having 20 to 30 dimensions and several hundred samples.

As a coping method for a case where the number of dimensions is large, there is a method that reduces the number of dimensions of data. However, when the number of dimensions is reduced, a dimension that gives important hints may not be visualized. Especially when data having both of large numbers of samples and dimensions is visualized in parallel coordinates, a method that limits the number of samples to or below a fixed number by resampling or clustering and reduces the amount of data has problems that the amount of calculation is large and also original data may not be faithfully visualized.

Moreover, there is also a method that finds an important dimension in a method such as machine learning. However, such an automation method is difficult to incorporate a user's domain knowledge and may not allow the user to make an efficient data analysis in expectation of user. In terms of visualization for the purpose of getting insight and understanding a trend in data, it is important to visualize data as it is to the extent possible rather than transform and then visualize data.

The data processing apparatus according to the embodiment generates data for displaying, in parallel coordinates, data of M dimensions (M is a natural number less than N) specified from N dimensions (N is a natural number) and, when the specification of the M dimensions is changed, updates visualization in parallel coordinates. Consequently, data with a large number of dimensions, or data with both of large numbers of dimensions and a large number of samples can be visualized in interactive parallel coordinates.

Multidimensional data is handled below as table data where dimensions correspond to columns and samples of data of the dimensions correspond to rows. The data of N dimensions from which the data of the M dimensions is extracted may be referred to as high-dimensional data, and the data of the M dimensions extracted from the high-dimensional data may be referred to as low-dimensional data. As in machine learning algorithms using multidimensional data, the dimensions may be handled as variables. In parallel coordinates, each axis corresponds to one dimension, and data of a corresponding dimension is displayed along its corresponding axis.

A variable that can be visualized in parallel coordinates includes a continuous variable (continuous variable) and an ordinal variable (ordinal variable). A nominal variable (nominal variable) can be visualized in parallel coordinates as an ordinal variable by determining some order (for example, the order of data indices) of its values. With a general-purpose personal computer, it is feasible to interactively visualize data with tens of dimensions and hundreds of samples in terms of delay in interactive parallel coordinates. More dimensions or samples may incur screen freezing or operational stress. According to the embodiment, it is possible to visualize parallel coordinates, targeting multidimensional data having dimensions and samples that are greater in number than these limits.

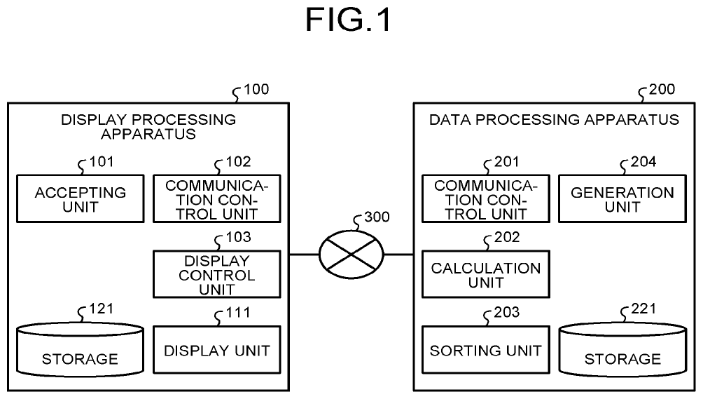

FIG. 1 is a block diagram illustrating an example of the configuration of a display control system according to the embodiment. As illustrated in FIG. 1, the display control system according to the embodiment is configured in such a manner that a display processing apparatus 100 and a data processing apparatus 200 are connected by a network 300 such as the Internet and a local area network (LAN). The network 300 may be a network in any connection mode such as wireless or wired.

The display processing apparatus 100 is a client apparatus such as a personal computer. The data processing apparatus 200 is, for example, a server apparatus. The display processing apparatus 100 and the data processing apparatus 200 may be each physically configured by one apparatus, or may be physically configured by a plurality of apparatuses. For example, the data processing apparatus 200 may be constructed as a server apparatus on a cloud environment.

Moreover, the configuration of the display control system illustrated in FIG. 1 is an example, and is not limited. For example, it may be configured in such a manner that one apparatus (for example, the data processing apparatus 200) includes each unit of the display processing apparatus 100 and each unit of the data processing apparatus 200. In this case, commonality may be provided to functions that can achieve commonality (for example, storage 121 and storage 221).

The display processing apparatus 100 includes a display unit 111, the storage 121, an accepting unit 101, a communication control unit 102, and a display control unit 103.

The display unit 111 is a display device such as a liquid crystal display that displays data. The display unit 111 follows control of the display control unit 103, and displays, for example, multidimensional data received from the data processing apparatus 200 in parallel coordinates.

The storage 121 stores various pieces of data used for various processes by the display processing apparatus 100. For example, the storage 121 stores data received from the data processing apparatus 200, the data being displayed on the display unit 111. The storage 121 can be configured by storage media of every kind generally used, such as flash memory, a memory card, Random Access Memory (RAM), a Hard Disk Drive (HDD), and an optical disc.

The accepting unit 101 accepts input of various pieces of data from a user or the like. For example, the accepting unit 101 accepts user operations such as the specification of the M dimensions displayed among the N dimensions and the specification of filtering conditions of each dimension. The method for inputting data by the user or the like can be any method. However, for example, a method that inputs with an input device such as a mouse, a keyboard, or a touchscreen can be used. The display unit 111 may be configured including a touchscreen for inputting data.

The communication control unit 102 controls communication with an external apparatus such as the data processing apparatus 200. For example, the communication control unit 102 transmits information (such as the specified M dimensions and filtering conditions) accepted by the accepting unit 101 to the data processing apparatus 200. Moreover, the communication control unit 102 receives data for display in parallel coordinates, from the data processing apparatus 200.

The display control unit 103 controls display of data on the display unit 111. For example, the display control unit 103 causes the display unit 111 to display data generated by the data processing apparatus 200 for display in parallel coordinates.

Each of the above units (the accepting unit 101, the communication control unit 102, and the display control unit 103) is realized by, for example, one or more processors. For example, each of the above units may be realized by causing a processor such as a Central Processing Unit (CPU) to execute a program, that is, software. Each of the above units may be realized by a processor such as a dedicated Integrated Circuit (IC), that is, hardware. Each of the above units may be realized by a combined use of software and hardware. If a plurality of processors is used, each processor may realize one of the units or two or more of the units.

Next, an example of the configuration of the data processing apparatus 200 is described. As illustrated in FIG. 1, the data processing apparatus 200 includes the storage 221, a communication control unit 201, a calculation unit 202, a sorting unit 203, and a generation unit 204.

The storage 221 stores various pieces of data used for various processes by the data processing apparatus 200. For example, the storage 221 stores multidimensional data targeted for display, and data (such as the specified M dimensions and filtering conditions) transmitted from the display processing apparatus 100. The storage 221 can be configured by storage media of every kind generally used, such as flash memory, a memory card, RAM, an HDD, and an optical disc.

The communication control unit 201 controls communication with an external apparatus such as the display processing apparatus 100. For example, the communication control unit 201 receives information (such as the specified M dimensions and filtering conditions) transmitted from the display processing apparatus 100. Moreover, the communication control unit 201 transmits data for display in parallel coordinates, to the display processing apparatus 100.

The calculation unit 202 calculates the number of focus dimensions, M, representing the number of dimensions that are extracted for display from the data of the N dimensions (focus dimensions). For example, the calculation unit 202 calculates the number of dimensions that allows data to be easily read when being displayed in a display area, as the number M of focus dimensions, on the basis of the width of the display area in parallel coordinates.

The sorting unit 203 generates a dimension list where dimensions of the N-dimensional data are arranged in an order in accordance with a predetermined sorting rule. The predetermined rule can be any rule in expectation of user. However, for example, a rule based on the variance or missing value of a data value, a rule based on the correlation between dimensions, and a rule using an importance scores obtained by machine learning can be applied.

The generation unit 204 generates data for displaying the data of the specified M dimensions in parallel coordinates. Moreover, when the specification of the M dimensions is changed, the generation unit 204 generates new data for displaying data of the changed M dimensions in parallel coordinates. Furthermore, the generation unit 204 may furtherly perform resampling that converts a plurality of pieces of data of each dimension of the M dimensions into fewer pieces of converted data. If the resampling is performed, the generation unit 204 generates new data for displaying the converted data in parallel coordinates.

Each of the above units (the communication control unit 201, the calculation unit 202, the sorting unit 203, and the generation unit 204) is realized by, for example, one or more processors. For example, each of the above units may be realized by causing a processor such as a CPU to execute a program, that is, software. Each of the above units may be realized by a processor such as a dedicated IC, that is, hardware. Each of the above units may be realized by a combined use of software and hardware. If a plurality of processors is used, each processor may realize one of the units or two or more of the units.

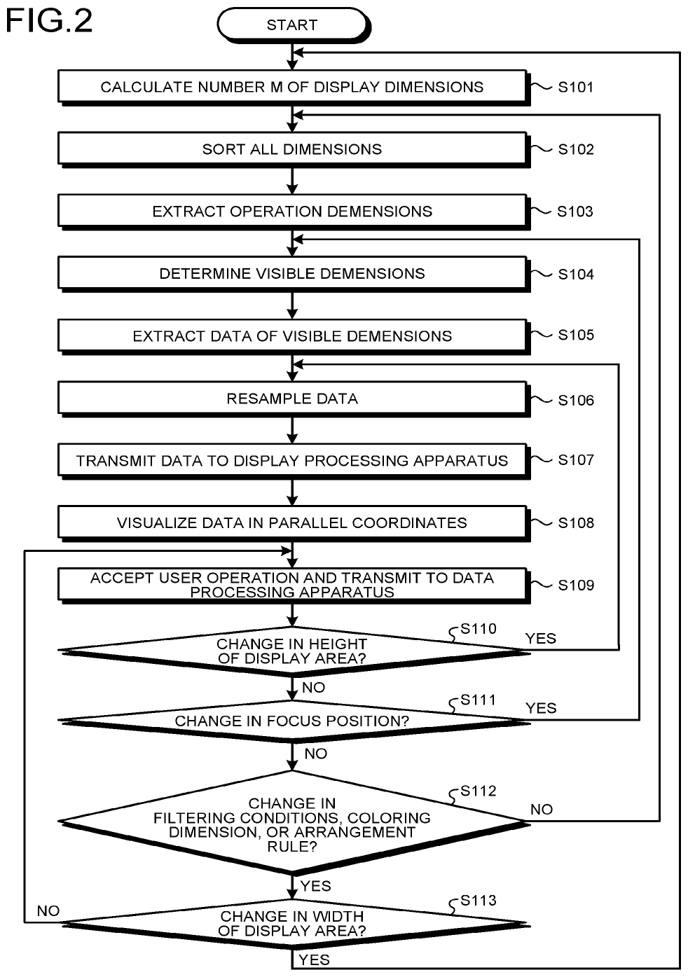

Next, a data visualization process by the display control system according to the embodiment configured in this manner is described in more detail. FIG. 2 is a flowchart illustrating an example of the data visualization process in the embodiment.

The calculation unit 202 of the data processing apparatus 200 calculates the number M of focus dimensions from the width of a display area in parallel coordinates (step S101) and interval between axes. The interval between two axes may be a fixed value, or may be able to be specified by user. In other way, the number M of focus dimensions is specified and the interval between axes is then computed accordingly.

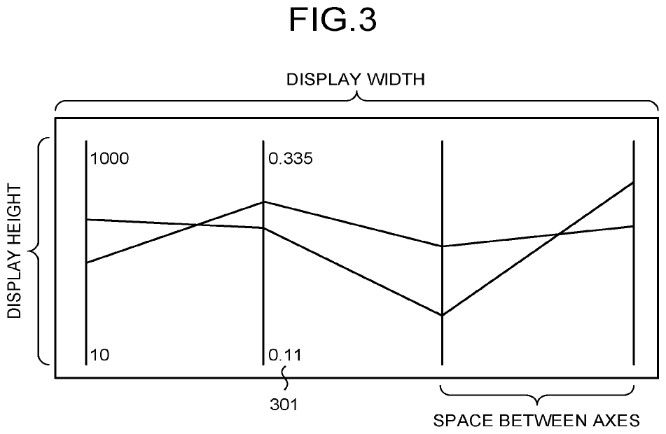

FIG. 3 is a diagram illustrating an example of the display area in parallel coordinates. The vertical lines correspond to axes or dimensions. A label 301 is displayed for each axis for identification. In parallel coordinates, as the number of axes is increased, a distance between axes (an interval between axes) is reduced, and the correlation of polylines between axes becomes unrecognized. An upper limit of the number of axes to be displayed is determined by the width of the display area and interval between axes of the parallel coordinates if the axes are drawn vertically. Theoretically, even 1000 axes can be drawn for a display area having width of 1000 pixels, but it becomes impossible to recognize axes and polylines in parallel coordinates. Generally, it is desired to set the interval between axes to equal to or greater than one-third of the height of the axis to make it easy to recognize labels of axes and polylines between adjacent axes.

Hence, the calculation unit 202 calculates the number of axes to be displayed simultaneously, that is, the number M of focus dimensions from the width of the display area and specified interval between axes. The calculation unit 202 calculates, for example, a value obtained by dividing the width of the display area by the interval between axes (the distance between axes) (if not divisible, a value rounded to a natural number may be used) as the number M of focus dimensions. For example, if the width of the display area in parallel coordinates is 1000 pixels, and the interval between axes is 50 pixels, the calculation unit 202 calculates M to 20 (=1000/50). The interval between axes may be a fixed value, or may be able to be specified by a user. For example, if the value of the interval between axes is changed by a user operation due to a change in the width or height of the display area, return to step S101. The calculation unit 202 recalculates the value of M.

Return to FIG. 2. The sorting unit 203 arranges all the dimensions in an order in accordance with a predetermined rule (step S102). The purpose of ordering dimensions is to allow user to efficiently find a desired dimension among a large numbers of dimensions.

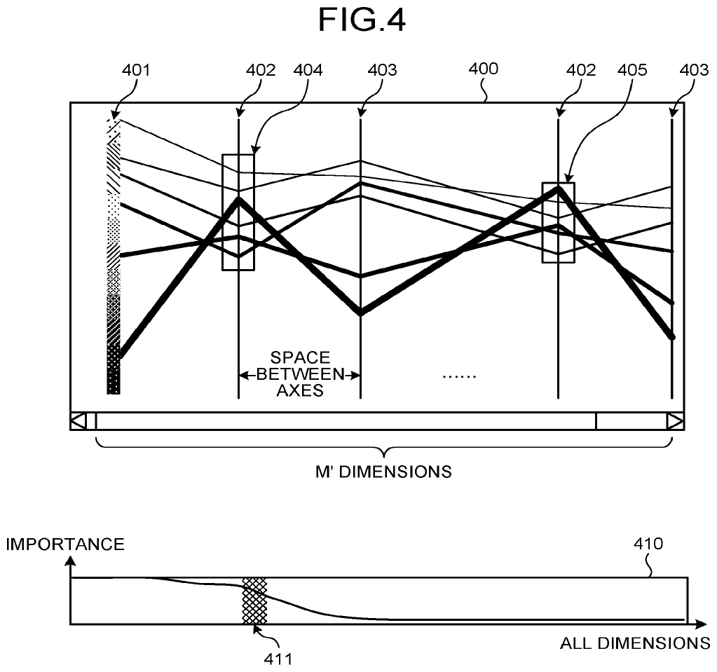

FIG. 4 is a diagram illustrating a user interface of the proposed parallel coordinates for a large number of dimensions. It consists of a display screen 400 and a focus specification screen 410. The display screen 400 may be displayed together with a focus specification screen 410. The focus specification screen 410 is a screen for specifying the position of focus dimensions (a focus position) among all the ordered dimensions. The focus specification screen 410 may be displayed on an apparatus different from the display processing apparatus 100. All of the ordered dimensions are mapped from left to right (or from right to left) on a slide bar on the focus specification screen 410 of FIG. 4. The user can specify focus dimensions with a knob 411 of the slide bar for all the dimensions.

In FIG. 4, a polyline corresponding to each sample is displayed in such a manner as to be different in thickness from each other. However, polylines are usually displayed in such a manner as to be different in color from each other. A dimension that assigns colors to polylines is a coloring dimension 401 (the details are described below). In FIG. 4, changes in the color of an axis of the coloring dimension 401 are expressed in changes in hatching.

The width of the knob 411 may be changed to allow the user to specify the number M of focus dimensions. In this case, the calculation unit 202 may calculate the value of the interval between axes that allows displaying the specified number M of focus dimensions. For example, the calculation unit 202 may calculate a value obtained by dividing the width of the display area by the specified number M of focus dimensions as the value of the interval between axes.

The order of dimensions is generally the descending order of importance of dimensions. In other words, the sorting unit 203 arranges the dimensions in accordance with a rule that makes an arrangement in the order of importance of dimensions. Consequently, the user can check dimensions from higher importance to lower importance while sliding with a slider bar to select dimensions.

The method for calculating importance according to the dimension can be various methods. As an easy method, for example, a method that calculates the variance of data values according to the dimension as importance, and a method that considers the count of missing values when computing importance can be also applied. The implementation details of importance computation should be customable by user in expectation of the use case.

As a complicated method, a method that calculates, as importance, the degree of correlation or sensitivity of a dimension x as an explanatory variable with another dimension y (an example of one or more first dimensions) specified as a dependent variable can be applied. For example, the degree of correlation of a pair by association between the dimension y being the dependent variable and each of a plurality of the dimensions x being the explanatory variables may be calculated as importance.

Moreover, the sorting unit 203 may use a machine learning model such as association rule (Association Rule) data mining, a decision tree, or a random forest. The machine learning model is constructed by learning in such a manner as to calculate the importance of each of the plurality of the dimensions x for the specified dimension y. The sorting unit 203 uses such a machine learning model to calculate the importance of each dimension x for the specified dimension y.

User may be able to change the rule of arrangement by the sorting unit 203. If the rule is changed, return to step S102. The sorting unit 203 makes an updating in accordance with the changed rule. Consequently, importance on which the user's intention is reflected can be instantly and interactively calculated.

Return to FIG. 2. The generation unit 204 also extracts dimensions that are manually operated (operation dimensions) (step S103). The operation dimensions are, for example, dimensions of reflecting current interest of the user. The operation dimensions are displayed in parallel coordinates as important information where the user's intention is reflected, irrespective of the order of dimensions. The operation dimensions may be explicitly specified by the user, or may be estimated by the generation unit 204 from various user interaction operations. The operation dimensions (an example of one or more first dimensions) include at least the coloring dimension and dimensions where filtering condition are set (filtering dimensions).

A coloring dimension is a dimension used for coloring in parallel coordinates. The data area (a minimum value to a maximum value) of the coloring dimension is mapped in a specified continuous color area. In other words, in terms of each sample, a value of the coloring dimension is associated with a certain color value. The color of a polyline corresponding to each sample is determined according to the setting of the coloring dimension.

A mode for displaying a polyline may be determined in a method other than color. For example, the generation unit 204 may determine display modes such as the thickness, shape, and presence or absence of blinking of a polyline depending on the value of data.

A filtering dimension is a dimension where a filter condition is applied. The filtering is a condition that is specified to filter the data of a certain dimension. The method for specifying the filtering conditions can be various methods. However, for example, a method that specifies the range of data along an axis can be applied. In FIG. 4, rectangles 404 and 405 indicate the ranges of data specified as the filtering conditions. The user can change the filtering by, for example, changing the position or height of the rectangle 404 or 405. Moreover, in FIG. 4, a dimension 402 where the filtering is specified as in the rectangle 404 or 405 corresponds to the filtering dimension.

A default display range of each dimension in parallel coordinates is, for example, the full range of its dimension. In other words, the entire data range along its dimension is targeted for visualization before the filtering conditions of a dimension is set. In terms of the filtering dimension, a part range of the dimension is selected according to the filtering conditions, and the selected data is targeted for visualization. A plurality of filtering conditions may be specified for each dimension. A plurality of filtering conditions of the same dimension is applied by taking a logical OR thereof. Filtering conditions of different dimensions are applied by taking a logical AND thereof.

If the filtering is changed, return to step S102. The sorting unit 203 makes an updating in accordance with the changed filtering conditions.

Return to FIG. 2. The generation unit 204 determines dimensions to be displayed in the parallel coordinates (visible dimensions) (step S104). The visible dimensions include the operation dimensions and focus dimensions. The generation unit 204 determines M focus dimensions from the dimension list on the basis of the focus position specified by the focus specification screen 410 or the like. Let the number of the operation dimensions be K. The generation unit 204 determines M′ (M′<=M+K) visible dimensions. The generation unit 204 extracts final dimensions after removing duplicate dimensions.

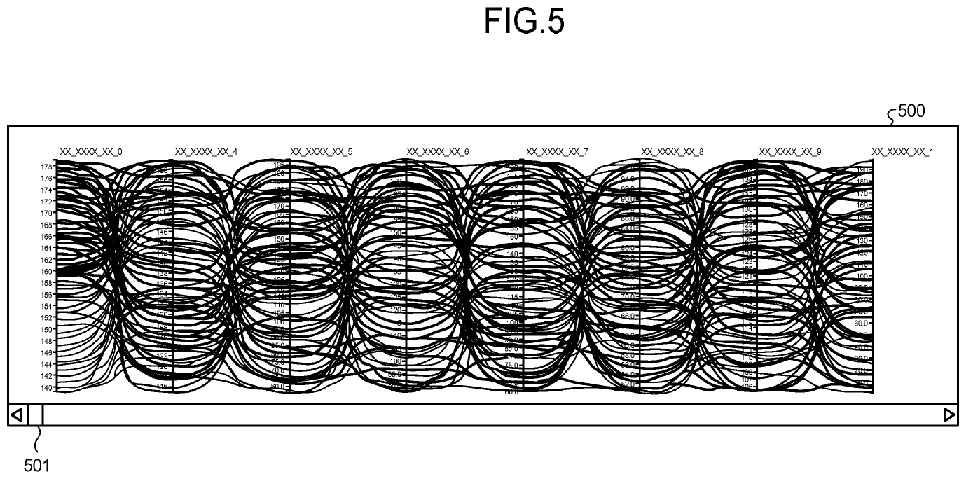

Another example of a user interface that specifies the focus position is described in FIG. 5. Similar as the method that uses the above-mentioned focus specification screen 410 of FIG. 4, a method that uses a display screen 500 illustrated in FIG. 5 specifies a focus position and update parallel coordinates interactively.

In the example of FIG. 4, as described above, the focus position is specified by the focus specification screen 410. As illustrated in FIG. 4, the display screen 400 includes the coloring dimension 401 and the filtering dimension 402, which are the operation dimensions, other than focus dimensions 403. The number M of focus dimensions is calculated on the basis of the width of the display area and the interval between axes. Therefore, a width necessary to display M′ axes of visible dimensions is greater than the width of the display area. FIG. 4 illustrates an example of the display screen 400 using the slide bar inside to make all M′ (M′<=M+K) dimensions visible to user. Instead of using the slide bar, it may be configured in such a manner that the interval between axes is recalculated to make visible of all the M′ dimensions (axes).

The display screen 500 illustrated in FIG. 5 is an example of a screen that displays all the M′ visible dimensions within the width of the display area. The user can specify the position of focus dimensions displayed in the display area (the focus position) with a knob 501 of a scroll bar at the bottom. In FIG. 5, the color of a polyline is drawn in black. However, a polyline of a color assigned to each sample of data of the coloring dimension (for example, a dimension at the left end) is usually displayed. All dimensions can be located with the bottom slide bar, but only M′ dimensions are displayed in a parallel coordinate visualization display at the top. In other words, the display processing apparatus 100 of FIG. 1 acquires low-dimensional (M′-dimensional) data, and draw parallel coordinates. If the slide bar is adjusted, the display processing apparatus 100 extracts low-dimensional data corresponding to the position of the adjusted slide bar position (and data of the operation dimensions), and updates the parallel coordinate display interactively and dynamically.

Moreover, it may be furtherly configured in such a manner that the user can manually customize the order of some dimensions to be displayed, in addition to the above-mentioned importance order of focus dimensions and filtering dimensions. The user manually specifies that a certain dimension A is placed before or after a dimension B by drag&drop operations, irrespective of the order of importance of the dimensions A and B, on, for example, the display screen of parallel coordinates. For example, the storage 121 stores the specified pair of the dimensions A and B (the paired dimensions). If one of the paired dimensions is included in the visible dimensions, the generation unit 204 adds the other dimension to the list of visible dimensions. In parallel coordinates, the order of dimensions before and after each dimension specified by paired dimensions is preferentially held irrespective of the order of dimensions (the order of importance) on the dimension list.

Return to FIG. 2. The generation unit 204 extracts data of the determined M′<=(M+K) visible dimensions from the high-dimensional (N-dimensional) data (step S105). For example, the use of a column-oriented database as a storage system for the high-dimensional data enables high-speed extraction of the low-dimensional data even in a case of large numbers of dimensions and samples.

In the processes up to this point (steps S101 to S105), the low-dimensional data is extracted from the high-dimensional data. However, even in a case of the low-dimensional data, as the number of samples (the number of rows of table data) increases, the transfer and plotting costs increase, and visual clutter (Clutter) may occur in parallel coordinates.

Hence, the generation unit 204 may resample data to reduce the data amount (step S106). Data resampling is a process of extracting or calculating representative samples from all samples (records). The generation unit 204 detects overlapping polylines and displays only representative polylines to efficiently visualize parallel coordinates. A method for precisely calculating resamples increases the calculation amount and accordingly is not suitable for interactive visualization of parallel coordinates.

One of resampling methods is a method that groups multidimensional data according to the distance between samples and obtains a representative value (such as a maximum value, a minimum value, an average value, a mean value, or a randomly extracted value) of each group according to the dimension.

The number of computed resamples increases roughly exponentially with the increasing number of dimensions. Therefore, as compared to resampling of the N-dimensional data, resampling of data of M′ visible dimensions in this embodiment reduces the number of resampled samples significantly.

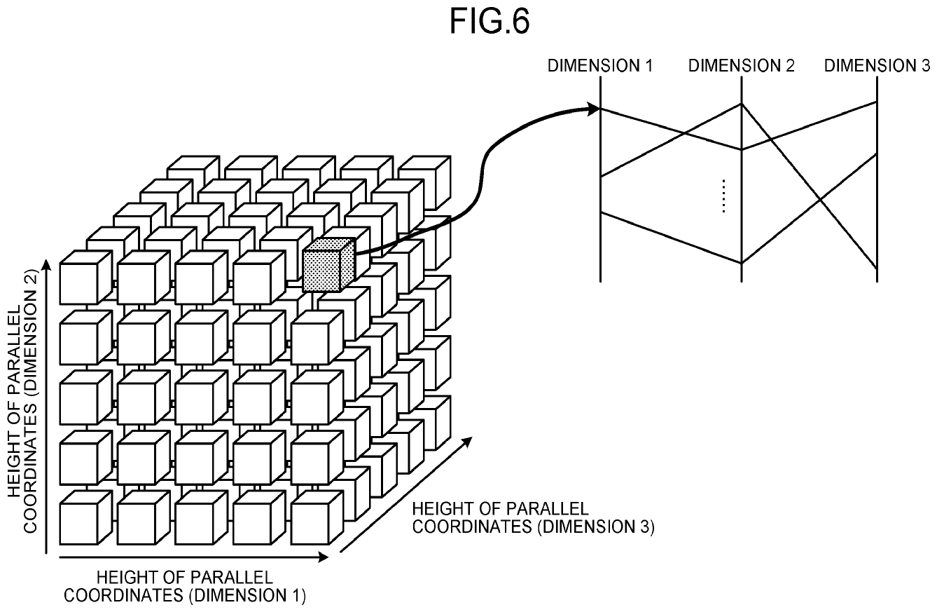

FIG. 6 is a diagram for explaining an example of resampling using a data cube. FIG. 6 illustrates an example where three-dimensional data is resampled, for convenience of description. However, the embodiment can target data of dimensions greater than three dimensions.

For example, a data cube having the same number of cells as the number of pixels indicating the height of the display area in parallel coordinates for each dimension is used. In FIG. 6, an example is illustrated in which the height of the display area is five pixels and the number of cells corresponding to each dimension is five. Supposed that the height of the display area is greater than five pixels. Each of the five pixels is associated with any of sub-sections obtained by splitting the height of the parallel coordinates into five sub-sections. Empty and no-empty cells are identified, and a representative (such as a maximum value, a minimum value, an average value, a mean value, or a randomly extracted value) of samples inside each cell is calculated or selected.

If the height of the display area in the parallel coordinates is changed by a user operation, the generation unit 204 computes update resamples.

Resampling is executed on base of whether or not the number of samples has exceeded a threshold specified by user. For example, in a case where data with a few samples is targeted, it is not necessary to execute resampling.

Return to FIG. 2. The communication control unit 201 transmits, to the display processing apparatus 100, the data generated by the generation unit 204 (the low-dimensional data or resampled data) (step S107).

The communication control unit 102 of the display processing apparatus 100 receives the data from the data processing apparatus 200. The display control unit 103 renders the received data into parallel coordinates (step S108). The display control unit 103 displays the data visualized in parallel coordinates as in, for example, the above-mentioned display screen of FIG. 4 or 5.

The display processing apparatus 100 includes an input device (such as a mouse, a keyboard, or a touchscreen) that can be operated by a user. The user can perform operations such as setting of filtering conditions for each dimension, and switching the coloring dimension on the display of the parallel coordinates, using the input device. Consequently, parallel coordinates can be interactively visualized.

In this manner, in the embodiment, the data processing apparatus 200 with compute-intensive hardware and large storage capacity executes a process on data with large numbers of dimensions and samples, and transmits the process result to the display processing apparatus 100 being a terminal apparatus that can be easily accessed and operated by the user. The display processing apparatus 100 executes a plotting process. In this manner, data processing and visualization (the display process) are distributed and executed. Accordingly, it is feasible to reduce the delay of a response to a user operation and encourage an improvement in performance as the entire display control system.

The method for distributed processing is not limited to this. For example, the data processing apparatus 200 may execute up to the plotting process of parallel coordinates, and transmit data indicating the plotting process result (screen data) to the display processing apparatus 100. In this case, the display control unit 103 of the display processing apparatus 100 is simply required to execute only the process of displaying the received screen data on the display unit 111. Moreover, it may be configured in such a manner that each of the data processing apparatus 200 and the display processing apparatus 100 executes part of the plotting process, and the display processing apparatus 100 displays the final plotting process result (screen data).

Steps S101 to S108 are a main flow of visualization of the proposed parallel coordinates. Steps S109 to S113 correspond to a process of feeding back a user operation to the corresponding step in main flow.

For example, once accepting a user operation through the input device, the accepting unit 101 of the display processing apparatus 100 transmits operation information indicating the accepted operation to the data processing apparatus 200 via the communication control unit 102 (step S109).

For example, the generation unit 204 of the data processing apparatus 200 determines whether or not the user operation indicates a change in the height of the display area, on the basis of the operation information (step S110). If the user operation triggers a change in the height of the display area (step S110: Yes), the generation unit 204 updates resamples on base of the changed height (step S106), and repeats the subsequent processing in the main flow.

If the user operation does not indicate a change in the height of the display area (step S110: No), the generation unit 204 determines whether or not the user operation indicates a change in focus position (step S111). If the user operation indicates a change in focus position (step S111: Yes), the generation unit 204 determines M focus dimensions on the basis of the changed focus position, furtherly determines visible dimensions in such a manner as to include the focus dimensions (step S104), and repeats the subsequent processing.

If the user operation does not indicate a change in focus position (step S111: No), the generation unit 204 determines whether or not the user operation indicates an addition or change of filtering conditions, the coloring dimension, or the arrangement rule (step S112). If the user operation indicates a change of filtering conditions, the coloring dimension, or the arrangement rule (Step S112: Yes), the processing is repeated from the arrangement process (step S102) by the sorting unit 203.

If the user operation does not indicate a change in filtering conditions, the coloring dimension, or the arrangement rule (step S112: No), the generation unit 204 determines whether or not the user operation indicates a change in the width of the display area (step S113). If the user operation indicates a change in the width of the display area (step S113: Yes), the processing is repeated from the process of calculating the number M of focus dimensions by the calculation unit 202 (step S101).

If the user operation does not indicate a change in the width of the display area (step S113: No), return to step S110 and wait until the next user operation is triggered. In this manner, a user operation is fed back and the display of parallel coordinates is interactively updated in accordance with the user operation.

The order of the determination processes of steps S110 to S113 is not limited to this, and any order of steps S110 to S113 is acceptable. Moreover, the user can specify several or all of the operations corresponding to steps S110 to S113 at a time. In this case, the display processing apparatus 100 may transmit operation information indicating a plurality of operations to the data processing apparatus 200. The data processing apparatus 200 may execute part or all of the determination processes of steps S110 to S113 at a time on the basis of, for example, the operation information. If the several conditions are satisfied in the plurality of determination processes, return to the earliest step among steps S101 to S106 along the main flow, and the processing is repeated.

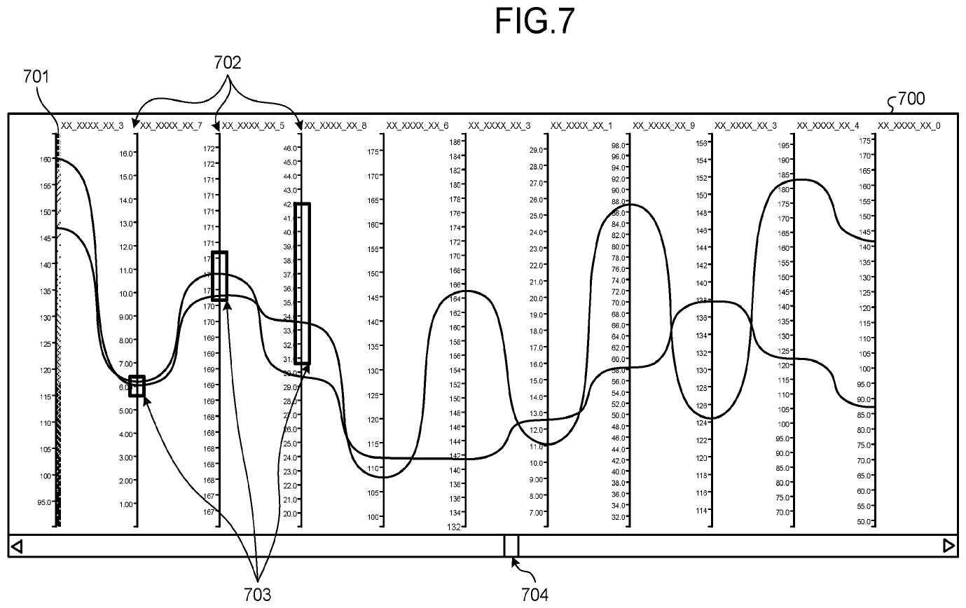

FIG. 7 is a diagram illustrating another example of the display screen in parallel coordinates. A dependent variable y is preferable to be a color dimension for the purpose of visual analysis. A display screen 700 illustrated in FIG. 7 is an example where a dimension 701 is set as the coloring dimension being a dependent variable y and is displayed together with other dimensions being explanatory variables for the coloring dimension in the parallel coordinates. The dimension 701 is displayed as a dimension at the left end in parallel coordinates. Filter dimensions 702 is dimensions where filtering conditions 703 is set (the operation dimensions) among the other dimensions. The visible dimensions (the operation dimensions and focus dimensions) are displayed in the parallel coordinates in the order of importance for the coloring dimension or the order of paired dimensions. The coloring dimension 701 is always displayed at the left end has the connotation that the dimension y have the highest degree of association with itself among the other dimensions x.

For example, when a user selects the dimension 701 as the coloring dimension, the dimension 701 is set as the dependent variable y, and the importance of the other dimensions being the explanatory dimensions x is recalculated by a machine learning model or the like. The other dimensions are arranged in the order of importance. A dimension corresponding to the focus position specified by the user (focus dimensions) in the slider bar is extracted from the arranged dimensions.

In the embodiment, even if a knob 704 of a scroll/slider bar changes the focus position, the dimension 701 (the coloring dimension) and the dimension 702 (the filtering dimension), which are the operation dimensions, are always displayed. For example, if the knob 704 is moved to the right from the state of FIG. 7, the dimensions 701 and 702 stay visible, and only the visible dimensions other than the dimensions 701 and 702 are updated in accordance with the new focus position. However, each dimension 702 is displayed according to the order of their importance scores. Accordingly, the order is updated. Such a configuration allows always displaying dimensions of interest of the user and displaying data of each dimension in the order of importance in parallel coordinates.

As described above, the data processing apparatus according to the embodiment extracts low-dimensional data and displays the data in parallel coordinates without displaying all dimensions of high-dimensional data (N-dimensional data) in parallel coordinates. Moreover, the display of parallel coordinates is updated with data of different dimensions sorted in the order of importance in accordance with a user operation. Consequently, the processing loads of data transfer and plotting even for data with a large number of dimensions of data or data with both of large numbers of dimensions and samples are reduced, and high-speed response performance can be realized with interactive visualization.

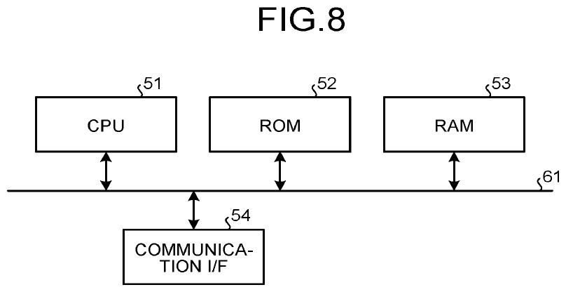

Next, a hardware configuration of each apparatus (the display processing apparatus and the data processing apparatus) according to the embodiment is described using FIG. 8. FIG. 8 is an explanatory diagram illustrating an example of the hardware configuration of the apparatus according to the embodiment.

The apparatus according to the embodiment includes a control device such as a CPU 51, storage devices such as a Read Only Memory (ROM) 52 and a RAM 53, a communication I/F 54 that communicates with a connection to a network, and a bus 61 connecting each unit.

A program that is executed by the apparatus according to the embodiment is previously incorporated in, for example, the ROM 52 and is provided.

The program that is executed by the apparatus according to the embodiment may be configured in such a manner as to be recorded in an installable or executable format file in a computer readable recording medium such as a Compact Disk Read Only Memory (CD-ROM), a flexible disk (FD), a Compact Disk Recordable (CD-R), or a Digital Versatile Disk (DVD) and be provided as a computer program product.

Furthermore, the program that is executed by the apparatus according to the embodiment may be configured in such a manner as to be stored on a computer connected to a network such as the Internet, downloaded via the network, and provided. Moreover, the program that is executed by the apparatus according to the embodiment may be configured in such a manner as to be provided or distributed via a network such as the Internet.

The program that is executed by the apparatus according to the embodiment can cause a computer to function as each unit of the above-mentioned apparatus. The computer can cause the CPU 51 to read the program from a computer readable storage medium onto a main storage device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising
one or more processors configured to
generate data for displaying, in parallel coordinates, data of M dimensions (M is a natural number less than N) specified from N dimensions (N is a natural number),
upon the specification of the M dimensions being changed, generate data for displaying data of the changed M dimensions in parallel coordinates.

2. The data processing apparatus according to claim 1, wherein the one or more processors
arrange dimensions of data of the N dimensions in an order in accordance with a predetermined rule,
generate data for arranging and displaying the data of the M dimensions (M is a natural number less than N) specified from the N dimensions in the order in parallel coordinates, and
upon the specification of the M dimensions being changed, generate data for arranging and displaying the data of the changed M dimensions in the order in parallel coordinates.

3. The data processing apparatus according to claim 2, wherein
the one or more processors arrange the dimensions in descending order of sensitivity to one or more first dimensions specified from the N dimensions.

4. The data processing apparatus according to claim 2, wherein
the one or more processors arrange the dimensions in descending order of sensitivity to one or more first dimensions used to determine a display mode of a polyline of the parallel coordinates among the N dimensions.

5. The data processing apparatus according to claim 2, wherein
upon filtering conditions being specified for one or more dimensions among the N dimensions, the one or more processors filter the data of the N dimensions in accordance with the filtering conditions, update the data of the N dimensions, and arrange dimensions of the updated data of the N dimensions in the order in accordance with the rule.

6. The data processing apparatus according to claim 4, wherein
the one or more processors add one or more first dimensions specified from the N dimensions, or one or more dimensions where the filtering conditions has been specified, to the M dimensions, and generate data for display in parallel coordinates.

7. The data processing apparatus according to claim 5, wherein
the one or more processors add one or more first dimensions specified from the N dimensions, or one or more dimensions where the filtering conditions has been specified, to the M dimensions, and generate data for display in parallel coordinates.

8. The data processing apparatus according to claim 4, wherein
upon the display order of dimensions being specified from the N dimensions, the one or more processors add all paired dimensions whose display order has been specified to any of the updated M dimensions, and generate data for display in parallel coordinates in such a manner as to preferentially hold the display order specified over the order.

9. The data processing apparatus according to claim 5, wherein
upon the display order of dimensions being specified from the N dimensions, the one or more processors add all paired dimensions whose display order has been specified to any of the updated M dimensions, and generate data for display in parallel coordinates in such a manner as to preferentially hold the display order specified over the order.

10. The data processing apparatus according to claim 1, wherein
upon the display order of dimensions being specified from the N dimension, the one or more processors add all paired dimensions whose display order has been specified to the M dimensions, and generate data for display in parallel coordinates in such a manner as to hold the display order.

11. The data processing apparatus according to claim 1, wherein
after generating the data of the M dimensions from the N dimensions, the one or more processors convert a plurality of original samples of data into resamples, the number of resamples being less than the number of the original samples of data, and display the resamples in parallel coordinates.

12. A display control system comprising: a data processing apparatus; and a display processing apparatus, wherein
the data processing apparatus includes
one or more processors configured to
generate data for displaying, in parallel coordinates, data of M dimensions (M is a natural number less than N) specified from N dimensions (N is a natural number),
upon the specification of the M dimensions being changed, generate data for displaying data of the changed M dimensions in parallel coordinates, and
the display processing apparatus includes
one or more processors configured to
display the generated data on a display device, and
accept the specification of the M dimensions displayed from the N dimensions.

13. A data processing method comprising the steps of:
generating data for displaying, in parallel coordinates, data of M dimensions (M is a natural number less than N) specified from N dimensions (N is a natural number); and
upon the specification of the M dimensions being changed, generating data for displaying data of the changed M dimensions in parallel coordinates.

14. A computer program product having a non-transitory computer readable medium including programmed instructions, wherein the instructions, when executed by a computer, cause the computer to perform:
generating data for displaying, in parallel coordinates, data of M dimensions (M is a natural number less than N) specified from N dimensions (N is a natural number), and
upon the specification of the M dimensions being changed, generating data for displaying data of the changed M dimensions in parallel coordinates.
